(19) United States
(12) Patent Application Publication
(10) Pub. No.: US 2005/0052403 A1
(43) Pub. Date: Mar. 10, 2005

(54) Liquid crystal display

(76) Inventor: Chih-Kuang Chen, Kaohsiung City (TW)

Correspondence Address: RABIN & Berdo, PC, 1101 14TH STREET, NW, SUITE 500, WASHINGTON, DC, 20005, US

(21) Appl. No.: 10/813,002

(22) Filed: Mar. 31, 2004

(30) Foreign Application Priority Data
Aug. 19, 2003 (TW) 92122796

(51) Int. Cl. G09G 3/36

(52) U.S. Cl. 345/102

(57) ABSTRACT

A liquid crystal display including a scan driver circuit, a liquid crystal display panel, a rotation speed control circuit, and a polygonal column reflector is provided. The liquid crystal display is used for receiving a scan activating signal outputted from the scan driver circuit to generate a frame display frequency accordingly. The rotation speed control circuit is used for receiving the scan activating signal to control a rotation of a motor accordingly. As a result, the polygonal column reflector can rotate synchronously with the motor while the motor rotating. The rotation speed of the polygonal column reflector corresponds to the frame display frequency. The light reflected from each of the reflecting side faces of the polygonal column reflector scans the liquid crystal display panel from one end of liquid crystal display panel to an opposite end of liquid crystal display panel.

This application claims the benefit of Taiwan application Serial No. 92122796, filed August. 19, 2003.

### BACKGROUND OF THE INVENTION

1. Field of the Invention

The invention relates in general to a liquid crystal display, and more particularly to a liquid crystal display with a rotary polygonal column reflector.

2. Description of the Related Art

With the advantage of low radiation and compactness, the liquid crystal display (LCD) is getting wider and wider use in terms of application. Featured by a higher luminance and wider view angle, the thin film transistor (TFT) LCD is now being widely used in hi-tech electronic products.

Referring to FIG. 1, a block diagram showing partial circuit structure of a conventional liquid crystal display. In FIG. 1, liquid crystal display 10 includes at least liquid crystal display panel 12, data driver circuit 13, and scan driver circuit 15, wherein liquid crystal display panel 12 includes at least a number of data lines 16, a number of scan lines 18, a number of TFTs 20 and a number of pixel electrodes 22. Of which, scan driver circuit 15 and data driver circuit 13 are disposed at two adjacent side faces of liquid crystal display panel 12; data lines 16 and scan lines 18 define a number of pixels 30 with each of pixels 30 including at least one TFT 20, one pixel electrode 22 and liquid crystal 28. The gate for TFT 20 of every pixel 30 is electrically connected to its corresponding scan line 18, while the drain or the source of TFT 20 of every pixel electrode 30 is electrically connected to its corresponding data line 16. Furthermore, the drain or the source of TFT 20 of every pixel electrode 30 is electrically connected to its corresponding pixel electrode 22 with each liquid crystal 28 being disposed atop of pixel electrode 22.

Data line 16 is electrically connected to data driver circuit 13 for transmitting the frame data signals outputted by data driver circuit 13 to all pixels 30. Scan line 18 is electrically connected to scan driver circuit 15 for transmitting the scan activating signals (shown in FIG. 2) outputted by scan driver circuit 15 to all pixels 30. In FIG. 2, S1˜Sn are signals outputted by respective scan lines 18 in FIG. 1 sequentially from top to bottom for sequentially activating TFT 20 in each row of pixel 30, so that the frame data signal of data line 16 may enter into pixel electrode 22 of corresponding pixel 30 to rotate liquid crystal 28. Meanwhile, the light enables liquid crystal display panel 12 to display corresponding frames via rotated liquid crystal 28. Moreover, scan activating signal may determine the frame display frequency of liquid crystal display panel 12, say, 60 frames per second.

Referring to both FIG. 3A and FIG. 3B. FIG. 3A is a partial three-dimensional diagram of the liquid crystal display shown in FIG. 1, while FIG. 3B is a partial side view of the liquid crystal display shown in FIG. 3A. In the two figures, liquid crystal display 10 is further equipped with light source 14 disposed beneath liquid crystal display panel 12 for providing liquid crystal display panel 12 with needed light for displaying a frame, while light source 14 is equipped with fluorescent tubes 14a ˜14f equally spread over in a fixed distance. Six fluorescent tubes are used herein for the purpose of exemplification; however, the actual number of fluorescent tubes needed depends on the size of the panel. Furthermore, fluorescent tubes 14a ˜14f are spread over in a direction parallel to that of scan line 18 in FIG. 1.

Normally, an intermittent control is applied to light source 14 in order to further improve the display quality of liquid crystal display panel 12. Referring to FIG. 4, a conventional circuit block diagram of liquid crystal display panel, scan driver circuit, light source intermittent control circuit and light source. In FIG. 4, liquid crystal display 10 is further equipped with light source intermittent control circuit 42 which is electrically connected to scan driver circuit 15 and light source 14. When scan driver circuit 15 outputs a scan activating signal to liquid crystal display panel 12, light source intermittent control circuit 42 receives the scan activating signal at the same time whereby the intermittent frequency of fluorescent tubes 14a˜14f of light source 14 is controlled accordingly. Of which, a corresponding relationship exists between the intermittent frequency and the scan activating signal. Also referring to FIG. 1, when the scan activating signal sequentially activates each row of pixel 30 in FIG. 1 from top to bottom, only the fluorescent tube (one of fluorescent tubes 14a˜14f corresponding to the activated row will be lit up to provide necessary light while the other tubes are not. Therefore, fluorescent tubes 14a˜14f achieve an impulse-type emission light source by means of an intermittent control.

However, with the design of an intermittent control of fluorescent tubes 14a˜14f, the luminance of light source 14 cannot be maintained at a fixed level. As a consequence, the overall frame luminance of liquid crystal display panel 12 will plunge and the display quality of liquid crystal display panel 12 will deteriorate significantly.

### SUMMARY OF THE INVENTION

It is therefore an object of the invention to provide a liquid crystal display, which, via the combination design of a polygonal column reflector and a light source, improves the overall luminance and display quality of the liquid crystal display panel without using any conventional intermittent control of light source.

The liquid crystal display according to the invention includes at least a scan driver circuit, a liquid crystal display panel, a rotation speed control circuit, and a polygonal column reflector. The scan driver circuit is used for outputting a scan activating signal. The liquid crystal display panel is used for receiving the scan activating signal to generate a frame display frequency accordingly. The rotation speed control circuit is used for receiving the scan activating signal to control the rotation of a motor accordingly. The polygonal column reflector is connected to and synchronizes with the motor using the central line of the column of the polygonal column reflector as an axis of rotation. The polygonal column reflector whose rotation speed corresponds to the frame display frequency has a number of reflecting side faces which sequentially reflect a light of a light source onto the liquid crystal display panel along with the rotation of the polygonal column reflector. The reflected light of each of reflecting side faces scans the liquid crystal display panel from one end of the liquid crystal display panel to one opposite end of the liquid crystal display panel for providing the liquid crystal display panel necessary light for each frame display.

The liquid crystal display according to the invention includes at least a scan driver circuit, a liquid crystal display panel, a number of rotation speed control circuits and a number of polygonal column reflectors. The scan driver circuit is used for outputting a scan activating signal, The liquid crystal display panel is used for receiving a scan activating signal to generate a frame display frequency accordingly. Each of the rotation speed control circuits is used for receiving the scan activating signal simultaneously to control the rotation of a motor. Each of the polygonal column reflectors respectively connects to the motor for synchronizing with the rotation of the motor using the center line of the column of the polygonal column reflector as an axis of rotation. The rotation speed of each of the polygonal column reflectors corresponds to the frame display frequency. Each of the polygonal column reflectors has a number of reflecting side faces which sequentially reflect the light of a light source onto the liquid crystal display panel along with the rotation of the polygonal column reflector. The reflected light of each of the reflecting side faces of each of the polygonal column reflectors synchronously scans the liquid crystal display panel from one end of the liquid crystal display panel to one opposite end of the liquid crystal display panel for providing the liquid crystal display panel necessary light for each frame display along with the rotation of the polygonal column reflectors.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing partial circuit structure of a conventional liquid crystal display;

FIG. 2 is a block diagram of the scan activating signals outputted by the scan driver circuit shown in FIG. 1;

FIG. 3A is a partial three-dimensional diagram of the liquid crystal display shown in FIG. 1;

FIG. 3B is a partial side view of the liquid crystal display shown in FIG. 3A.

FIG. 4 is a conventional circuit block diagram of liquid crystal display panel, scan driver circuit, light source intermittent control circuit and light source;

FIG. 5 shows a block diagram of partial circuit structure of a liquid crystal display according to preferred embodiment one of the invention;

FIG. 6 is a three-dimensional assembly diagram for the motor and polygonal column reflector shown in FIG. 5;

FIG. 7A shows a side view of partial circuit structure of a liquid crystal display according to preferred embodiment one of the invention;

FIG. 7B shows the status of the reflected light of the reflecting side faces in FIG. 7A scanning through the surface of the liquid crystal display;

FIG. 7C shows the status of the reflected light of the reflecting side faces in FIG. 7A arriving at the other end of the liquid crystal display;

FIG. 8 shows the status of installing a convex lens between the light source and the polygonal column reflector according to the invention;

FIG. 9A is an enlargement showing the status of installing a light absorbing material at the junction of any two adjacent reflecting side faces of the polygonal column reflector in FIG. 7A according to the invention;

FIG. 9B is an enlarged cross section showing the status of forming the polygonal column reflector in FIG. 7 using a hollow column casing and a reflecting material according to the invention;

FIG. 9C is an enlarged cross section showing the status of forming the polygonal column reflector in FIG. 7 using a column body and a reflecting material according to the invention;

FIG. 10 shows a partial circuit structure of a liquid crystal display according to preferred embodiment two of the invention;

FIG. 11 is a three-dimensional assembly diagram for the first and the second motors and the first and the second polygonal column reflectors shown in FIG. 10;

FIG. 12A shows a side view of partial circuit structure of a liquid crystal display according to preferred embodiment two of the invention;

FIG. 12B shows the status of the reflected light of a first reflecting side face and its corresponding second reflecting side face in FIG. 12A simultaneously arriving at the other end of the liquid crystal display panel.

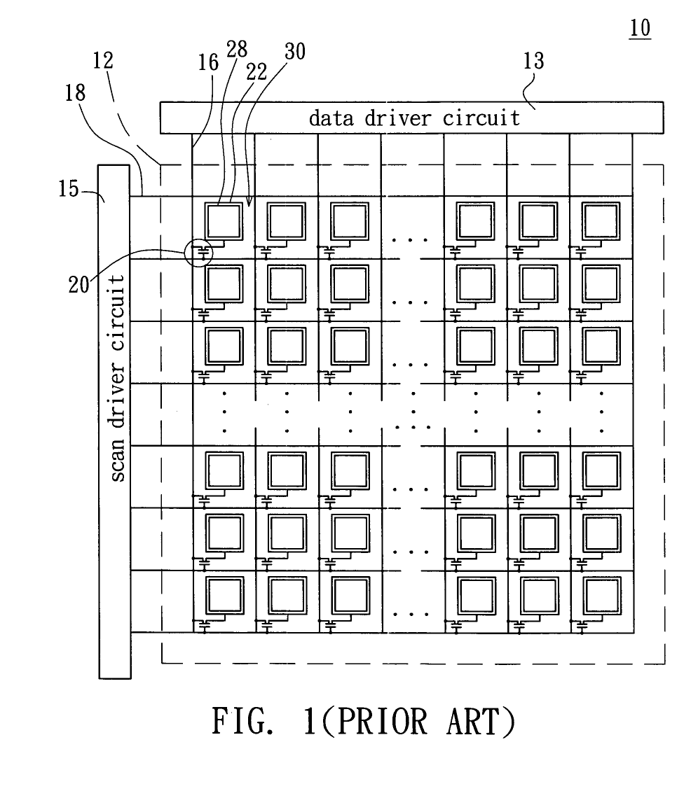

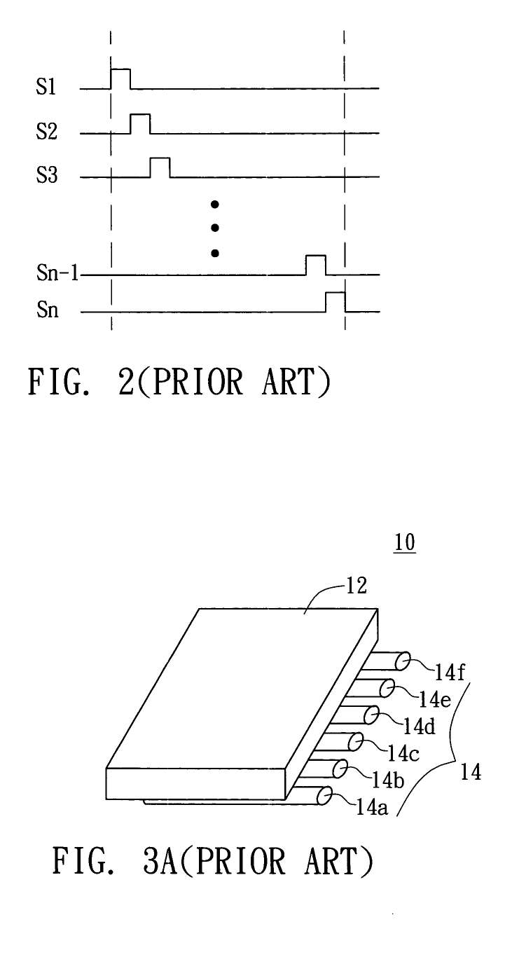

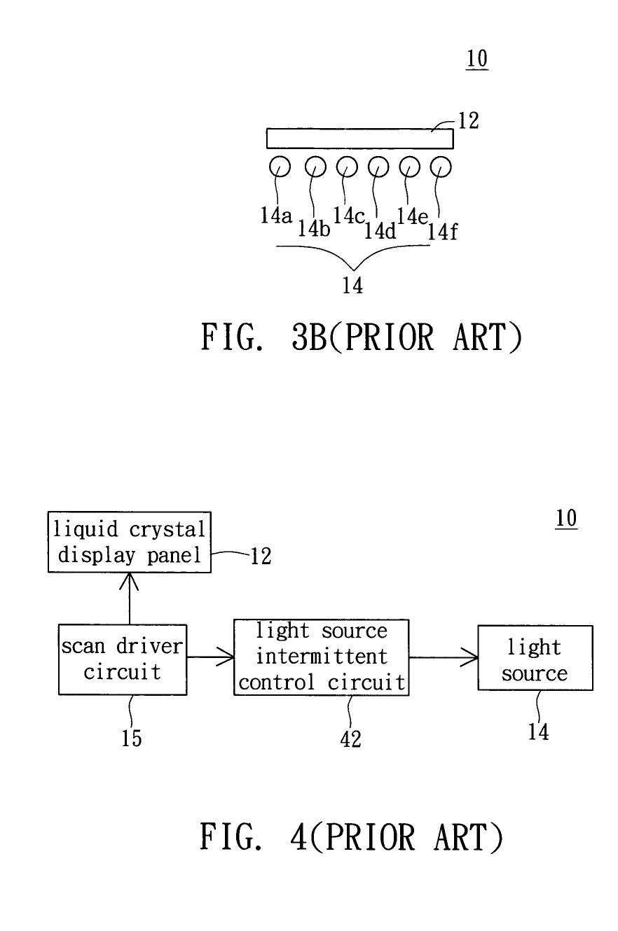

### DETAILED DESCRIPTION OF THIS INVENTION

Preferred Embodiment One:

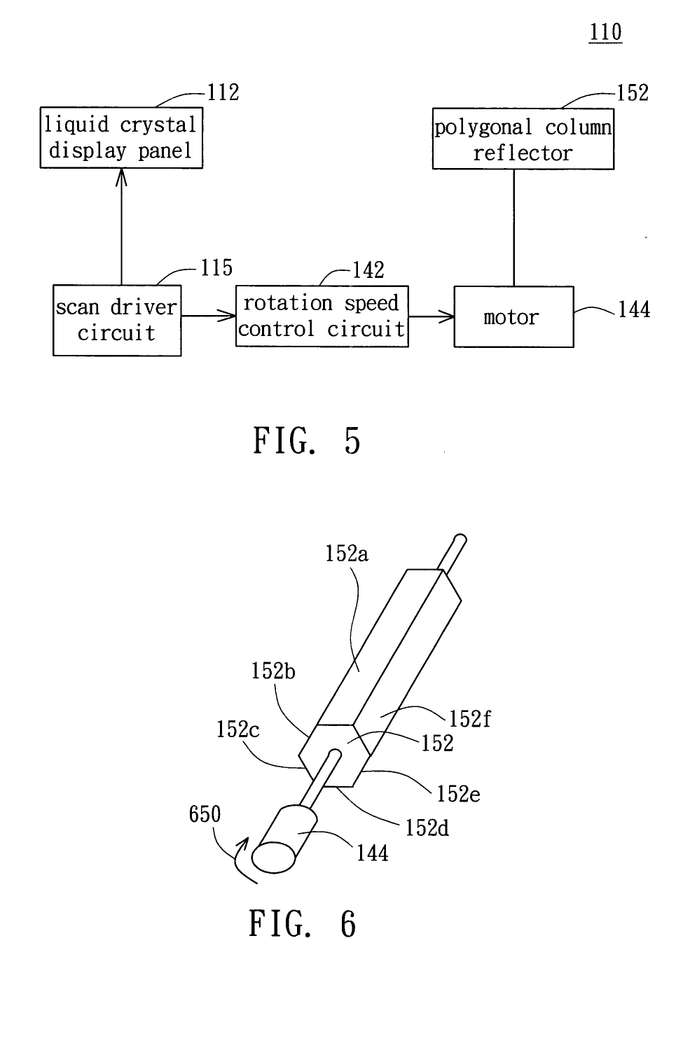

Referring first to FIG. 5, a block diagram of partial circuit structure of a liquid crystal display according to preferred embodiment one of the invention. In FIG. 5, liquid crystal display 110 includes at least liquid crystal display panel 112, scan driver circuit 115, rotation speed control circuit 142, motor 144 and polygonal column reflector 152. In preferred embodiment one, polygonal column reflector 152 is illustrated by example of a regular polygonal column reflector. Scan driver circuit 115 is electrically connected to liquid crystal display panel 112 for simultaneously outputting a scan activating signal to liquid crystal display panel 112 and rotation speed control circuit 142 so that liquid crystal display panel 112 will generate a frame display frequency. Rotation speed control circuit 142 is electrically connected to motor 144 for receiving the scan activating signal to control the rotation speed of motor 144 accordingly. Polygonal column reflector 152 is mechanically connected to motor 144 for synchronizing with the rotation of motor 144 along with the direction of arrow 650 shown in FIG. 6. Furthermore, the rotation speed of polygonal column reflector 152 corresponds to the frame display frequency of liquid crystal display panel 112.

In FIG. 6, polygonal column reflector 152 has a number of reflecting side faces. In the present embodiment, 6 reflecting side faces reflecting side faces, namely 152a˜152f, are used for illustration. Each of the reflecting side faces 152a ˜152f sequentially reflects the light onto liquid crystal display panel 112 along with the rotation of polygonal column reflector 152, wherein any of reflecting side faces 152a ˜152f is able to provide needed light for each frame display on liquid crystal display panel 112.

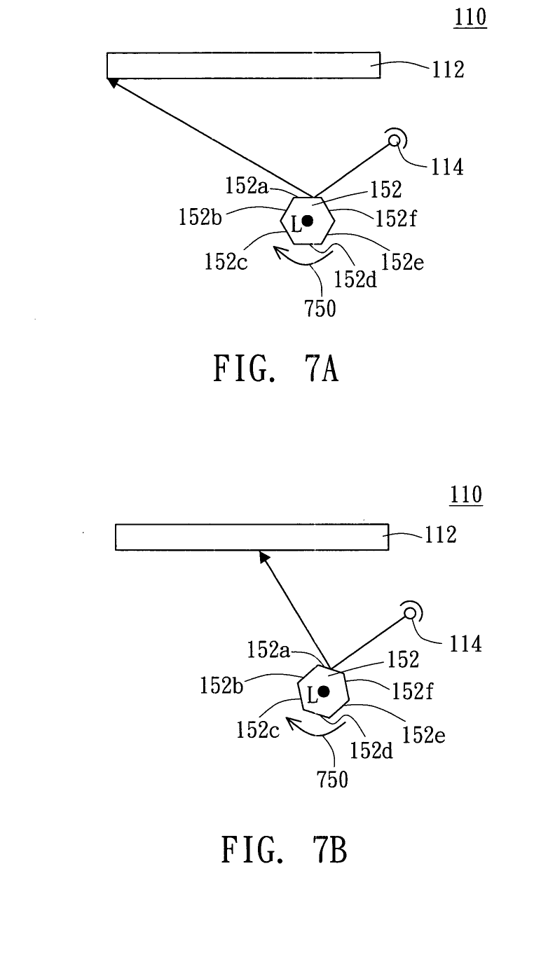

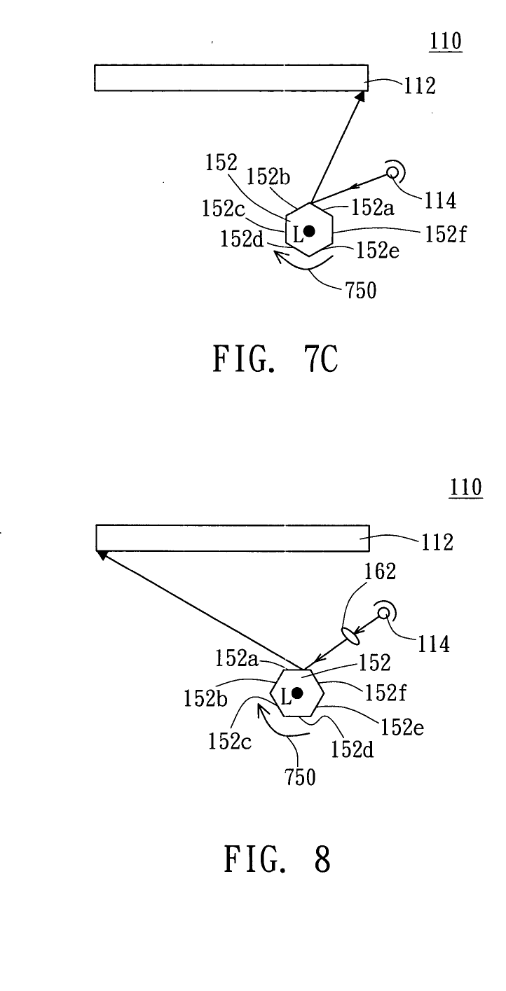

Referring to FIG. 7A, a side view of partial circuit structure of a liquid crystal display according to preferred embodiment one of the invention. In FIG. 7A, liquid crystal display 110 further includes light source 114 which is used for providing light to any of reflecting side faces 152a ˜152f of polygonal column reflector 152. Of which, polygonal column reflector 152 extends in a direction parallel to that of the scan line on liquid crystal display panel 112.

When liquid crystal display panel 112 and rotation speed control circuit 142 in FIG. 5 receive a scan activating signal, polygonal column reflector 152 will synchronize with the rotation of motor 144 of FIG. 6 along with the direction of arrow 750 in FIG. 7A, using L, the central line of the column, as an axis of rotation. Along with the rotation of polygonal column reflector 152, reflecting side face 152a will reflect the light of light source 114 to one end of the surface of liquid crystal display panel 112 wherein the light will scan through the surface of liquid crystal display panel 112 as shown in FIG. 7B. Finally, the reflected light of reflecting side face 152a will arrive at the opposite end of the surface of liquid crystal display panel 112 as shown in FIG. 7C. Reflecting side face 152a provides liquid crystal display panel 112 with needed light for frame display, while the needed light for the display of next frame will be provided by reflecting side face 152b. By the same token, reflecting side faces 152a˜152f will provide liquid crystal display panel 112 with needed light for every frame display.

Of which, the rotation speed of polygonal column reflector 152 must correspond to the frame display frequency of liquid crystal display panel 112. Moreover, the scanning speed of the reflected light coming from any of reflecting side faces 152a ˜152f must be in tune with the speed for every pixel row on liquid crystal display panel 112 to be activated by the scan activating signal. Suppose the frame display frequency of liquid crystal display panel 112 is 60 frames per second, polygonal column reflector 152 must have 10 rotations per second. After being reflected by polygonal column reflector 152, the covering area of the light coming from light source 114 will extend from one end of the surface of liquid crystal display panel 112 to the opposite end thereof with the rotation speed of liquid crystal display panel 112 and the frame display frequency of liquid crystal display panel 112 being synchronically controlled. According to the invention, the combined design of polygonal column reflector 152 and light source 114 not only dispenses conventional intermittent control of light source, but also improves the overall luminance of motion display and quality of liquid crystal display panel 112.

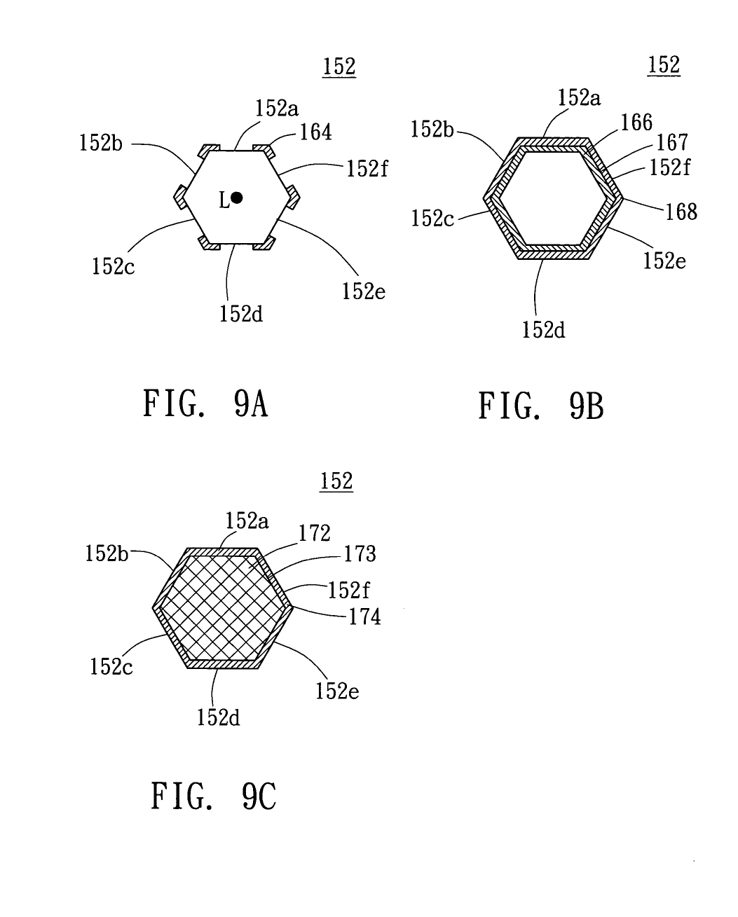

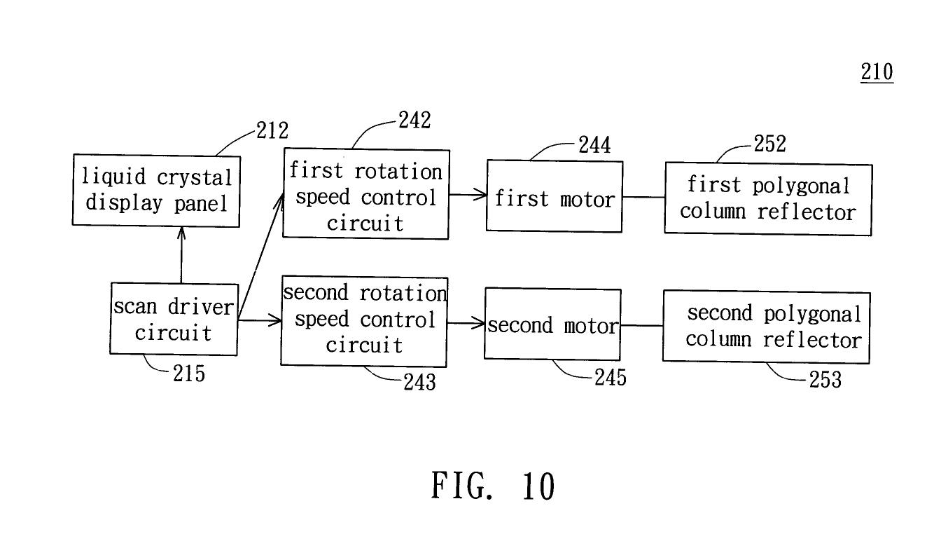

The invention can also installs convex lens 162 between light source 114 and polygonal column reflector 152 as shown in FIG. 8. Convex lens 162 is for focusing the light emitted from the light source 114 on each of reflecting side faces 152a˜152f to enhance the intensity of the light reflected from reflecting side faces 152a˜152f. As shown in FIG. 9A, a number of light absorbing material 164 may be coated or adhered at the junction of any two adjacent reflecting side faces of reflecting side faces 152a˜152f for avoiding the light scattering phenomenon occurring at the above junctions.

The design for the structure and material of polygonal column reflector 152 are elaborated below by means of drawings and explanations. For example, polygonal column reflector 152 can include a hollow column casing 166 and a number of reflecting materials 168 as shown in FIG. 9B. In FIG. 9B, hollow column casing 166 has a number of casing side faces 167 with reflecting materials 168 being coated or adhered thereto forming the above reflecting side faces 152a˜152f, wherein hollow column casing 166 can be made of plastics while reflecting materials 168 can be a number of aluminum slices or reflecting mirrors. Furthermore, as shown in FIG. 9C, polygonal column reflector 152 can include a column body 172 and a number of reflecting materials 174, wherein column body 172 has a number of body side faces 173. Reflecting materials 174 are coated or adhered to body side faces 173 respectively forming the above mentioned reflecting side faces 152a˜152f. Column body 172 can be made of plastics while reflecting materials 174 can be a number of aluminum slices or reflecting mirrors.

Preferred Embodiment Two:

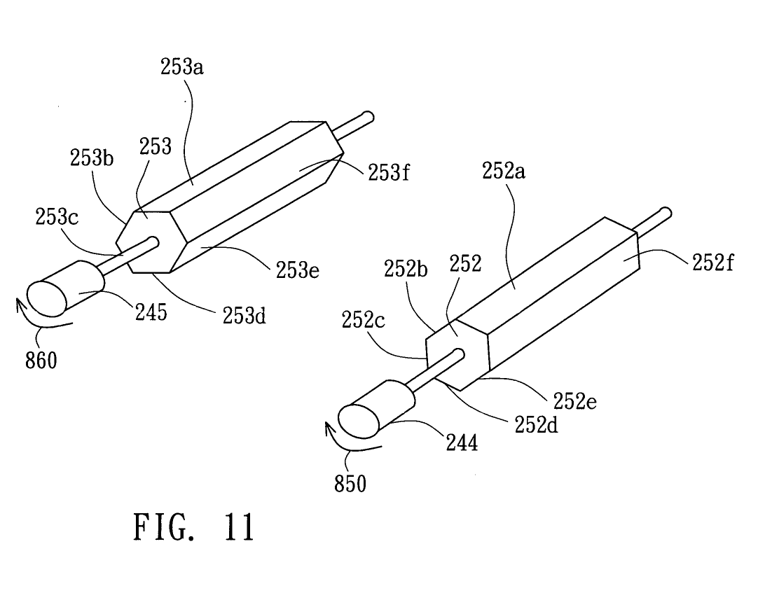

Referring to FIG. 10, a partial circuit structure of a liquid crystal display according to preferred embodiment two of the invention. In FIG. 10, liquid crystal display 210 includes at least liquid crystal display panel 212, scan driver circuit 215, a number of rotation speed control units, a number of motors and a number of polygonal column reflector, such as first rotation speed control circuit 242 and second rotation speed control circuit 243, first motor 244 and second motor 245, first polygonal column reflector 252 and second polygonal column reflector 253. In preferred embodiment two, first polygonal column reflector 252 and second polygonal column reflector 253 are illustrated by example of regular polygonal column reflectors. Scan driver circuit 215 is electrically connected to liquid crystal display panel 212, first rotation speed control circuit 242 and second rotation speed control circuit 243 for simultaneously outputting a scan activating signal to liquid crystal display panel 212, first rotation speed control circuit 242 and second rotation speed control circuit 243, so that liquid crystal display panel 212 will generate a frame display frequency accordingly. First rotation speed control circuit 242 and second rotation speed control circuit 243 are respectively electrically connected to first motor 244 and second motor 245 for simultaneously receiving the scan activating signal whereby the rotation speed of first motor 244 and that of second motor 245 are controlled accordingly. First polygonal column reflector 252 and second polygonal column reflector 253 are connected to first motor 244 and second motor 245 respectively as shown in FIG. 11 for synchronizing with the rotation of first motor 244 and that of second motor 245 respectively along with the direction of arrow 850 and that of arrow 860 shown in FIG. 11. Furthermore, the rotation speed of first polygonal column reflector 252 and that of second polygonal column reflector must correspond to the frame display frequency of liquid crystal display panel 212.

In FIG. 11, both first polygonal column reflector 252 and second polygonal column reflectors 253 have a number of reflecting side faces. For example, first polygonal column reflector 252 has 6 first reflecting side faces numbered from 252a to 252f, while second polygonal column reflector 253 has 6 second reflecting side faces numbered from 253a to 253f. Each of the first reflecting side faces 252a ˜252f sequentially reflects the light onto liquid crystal display panel 212 along with the rotation of first polygonal column reflector 252, while the corresponding second reflecting face of the second reflecting side faces 253a ˜253f sequentially reflects the light onto liquid crystal display panel 212 along with the rotation of second polygonal column reflector 253.

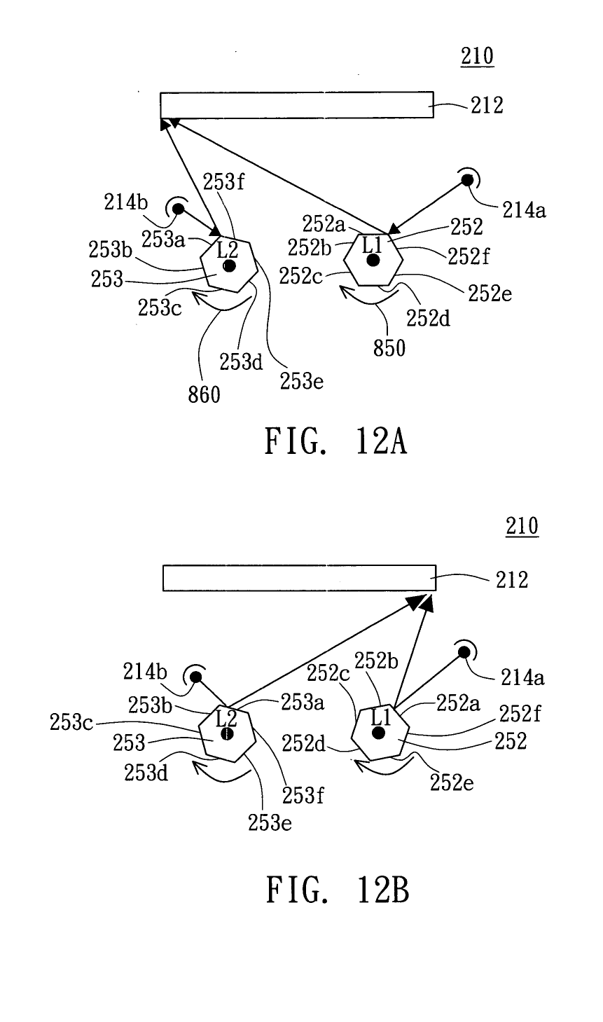

Referring to FIG. 12A, a side view of partial circuit structure of a liquid crystal display according to preferred embodiment two of the invention. In FIG. 12A, liquid crystal display 210 further includes first light source 214a and second light source 214b. First light source 214a is used for providing light to one of first reflecting side faces 252a˜252f, while second light source 214b is used for providing light to one of second reflecting side faces 253a˜253f. Of which, both polygonal column reflector 252 and polygonal column reflector 253 extend in a direction parallel to the scan line on liquid crystal display panel 212.

When liquid crystal display panel 212 and first rotation speed control circuit 242 and second rotation speed control circuit 243 in FIG. 5 receive the scan activating signal, first polygonal column reflector 252 and second polygonal column reflector 253 will respectively synchronize with the rotation of first motor 244 and that of second motor 245 in FIG. 11 along with the direction of arrow 850 and the direction of arrow 860 in FIG. 12A using L1 and L2, the central line of respective column, as respective axis of rotation. Along with the rotation of first polygonal column reflector 252 and that of second polygonal column reflector 253, first reflecting side face 252a and second reflecting side face 253a will respectively reflect the light of first light source 214a and that of second light source 214b onto one end of the surface of liquid crystal display panel 212 wherein the reflected light will scan through the surface of liquid crystal display panel 212. Finally, the reflected light of first reflecting side face 252a and that of second reflecting side face 253a will arrive at the opposite end of the surface of liquid crystal display panel 212 as shown in FIG. 12B. Both first reflecting side face 252a and second reflecting side face 253a provide liquid crystal display panel 212 with needed light for a frame display, while the needed light for the display of next frame will be provided by first reflecting side face 252b and second reflecting side face 253b. By the same token, first reflecting side faces 252a ˜252f and their corresponding second reflecting side faces 253a˜253f will provide liquid crystal display panel 212 with needed light for every frame display.

The rotation speed of first polygonal column reflector 252 and that of second polygonal column reflector 253 must correspond to the frame display frequency of liquid crystal display panel 212. Moreover, the scanning speed of the reflected light coming from any of first reflecting side faces 252a ˜252f and that coming from any of any of second reflecting side faces 253a ˜253f must be in tune with the speed for every pixel row on liquid crystal display panel 212 to be activated by the scan activating signal. Suppose the frame display frequency of liquid crystal display panel 212 is 60 frames per second, first polygonal column reflector 252 and second polygonal column reflector must have 10 synchronic rotations per second. The invention uses dual light beam scan to enhance the overall luminance of liquid crystal display panel 212 and further adjust the phase difference of scan between the two light beams to achieve an optimization of motion picture quality.

The invention can also installs a convex lens between first light source 214a and first polygonal column reflector 252, or further installs a convex lens between second light source 214b and second polygonal column reflector 253 to enhance the intensity of the reflected light. The invention can further coat or adhere a number of light absorbing materials to the junction of any two adjacent reflecting side faces of first reflecting side faces 252a ˜252f and to the junction of any two adjacent reflecting side faces of second reflecting side faces 253a ˜253f for avoiding the light scattering phenomenon occurring at the above junctions. The design for the structure and material of first polygonal column reflector 252 and second polygonal column reflector 253 are the same with that of polygonal column reflector 152 disclosed in preferred embodiment one and will not be repeated here.

Anyone who is familiar with the above technology will understand that the technology of the invention is not limited thereto. For example, the light source in the invention can also be a cold cathode fluorescent lamp (CCFL) or a row of light emitting diode (LED). If CCFL is adapted as the light source, the invention can further install a reflecting light base to intensify the light of the CCFL. Moreover, the length of polygonal column reflector is greater than or equal to that of light source. The polygonal column reflector can be a polygonal aluminum column body or a hollow polygonal aluminum column casing.

The liquid crystal display disclosed in the above preferred embodiments of the invention has a combined design of polygonal column reflector and light source. This design not only dispenses conventional intermittent control of light source, but also improves the overall luminance and display quality of liquid crystal display panel.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A liquid crystal display comprising:
a scan driver circuit for outputting a scan activating signal;
a liquid crystal display panel for receiving the scan activating signal to generate a frame display frequency accordingly;
a rotation speed control circuit for receiving a scan activating signal to control a rotation speed of a motor accordingly; and
a polygonal column reflector connected to the motor for synchronizing with the rotation of the motor using the center line of the column of the polygonal column reflector as an axis of rotation, wherein the rotation speed of the polygonal column reflector corresponds to the frame display frequency, moreover, the polygonal column reflector has a plurality of reflecting side faces which sequentially reflect the light of a light source onto the liquid crystal display panel along with the rotation of the polygonal column reflector;
wherein the reflected light of each of the reflecting side faces scans the liquid crystal display panel from one end of the liquid crystal display panel to one opposite end of the liquid crystal display panel along with the rotation of the polygonal column reflector so that light required for each frame display is provided.

2. The liquid crystal display according to claim 1, wherein the polygonal column reflector further comprises:
a column body with a plurality of body side faces; and
a plurality of reflecting materials disposed onto the body side faces, respectively.

3. The liquid crystal display according to claim 2, wherein the reflecting materials are a plurality of aluminum slices.

4. The liquid crystal display according to claim 2, wherein the reflecting materials are a plurality of reflecting mirrors.

5. The liquid crystal display according to claim 2, wherein the column body is hollow.

6. The liquid crystal display according to claim 1, wherein the liquid crystal display further comprises:
a plurality of light absorbing materials disposed at the junction of every two adjacent reflecting side faces of the reflecting side faces.

7. The liquid crystal display according to claim 1, wherein the liquid crystal display further comprises:
a convex lens disposed between the light source and the polygonal column reflector for focusing the light from the light source on the reflecting side faces.

8. A liquid crystal display comprising:
a scan driver circuit for outputting a scan activating signal;
a liquid crystal display panel for receiving the scan activating signal to generate a frame display frequency accordingly;
a plurality of rotation speed control circuits, each of the rotation speed control circuits for receiving a scan activating signal to control a rotation speed of a motor; and
a plurality of polygonal column reflectors, each of the polygonal column reflectors respectively connected to the motor for synchronizing with the rotation of the motor using the center line of the column of the polygonal column reflector as an axis of rotation, wherein the rotation speed of each of the polygonal column reflectors corresponds to the frame display frequency, moreover, each of the polygonal column reflectors has a plurality of reflecting side faces which sequentially reflect the light of a light source onto the liquid crystal display panel along with the rotation of the polygonal column reflector;
wherein the reflected light from of each of the reflecting side faces of each of the polygonal column reflectors synchronously scans the liquid crystal display panel from one end of the liquid crystal display panel to one opposite end of the liquid crystal display panel along with the rotation of the polygonal column reflectors so that light required for each frame display is provided.

9. The liquid crystal display according to claim 8, wherein the liquid crystal display further comprises:
a plurality of light absorbing materials disposed at the junction of every two adjacent second reflecting side faces of the second reflecting side faces.
